(19) United States
(12) Patent Application Publication
(10) Pub. No.: US 2004/0040038 A1
(43) Pub. Date: Feb. 26, 2004

(54) Program guide display apparatus

(75) Inventors: Mitsuru Sasaki, Hyogo (JP); Minoru Maehata, Hyogo (JP); Yasuo Nakashima, Hyogo (JP); Hideshi Nishizawa, Hyogo (JP); Masahiro Kamiya, Hyogo (JP); Hideki Nakamura, Hyogo (JP); Masahiko Kitagawa, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 10/458,378

(22) Filed: Jun. 11, 2003

(30) Foreign Application Priority Data
Jun. 19, 2002 (JP) 2002-178570

(51) Int. Cl. G06F 3/00; H04N 5/445; G06F 13/00

(52) U.S. Cl. 725/44; 725/55

(57) ABSTRACT

A program guide display apparatus includes control unit for reading program data from RAM for storing a plurality of pieces of program data and controlling display unit so as to change the order of the display positions of program descriptions displayed in a table format in response to input unit and can display the program descriptions in the display order responsive to the operator's liking, improving the convenience of the operator. For example, the program descriptions of the programs of the broadcast station to be checked by the operator can be placed at positions of a display screen where the operator can easily see the program descriptions. For example, the two program descriptions to be compared can be displayed so that they are contiguous. The screen need not be scrolled and the program descriptions of the programs to be checked by the operator can be displayed in one screen.

The present disclosure relates to the subject matter contained in Japanese Patent Application No.2002-178570 filed on Jun. 19, 2002, which is incorporated herein by reference in its entirety.

### BACKGROUND OF THE INVENTION

1. Field of the Invention

This invention relates to a program guide display apparatus suitably used for receiving a digital broadcast, for example, and displaying electronic program guide (EPG) information contained in the received digital broadcast.

2. Description of the Related Art

Digital broadcasts capable of broadcasting high-quality video and audio and providing multifunctional broadcasting as compared with analog broadcasts for broadcasting video information and audio information by analog signals are becoming increasingly common. BS digital broadcasts using a broadcast satellite were started in 2000 and subsequently, ground wave digital broadcasts using ground antennas are scheduled for start in 2003.

FIG. 21 is a drawing to show a broadcast wave of digital broadcasting. On a broadcast wave 1 of digital broadcasting, a program signal representing the broadcast program is multiplexed for broadcasting. One broadcast wave 1 contains audio and image data 2 to send audio and moving picture of each program and program data 3 to display electronic program guide information.

FIG. 22 is a drawing to show the data structure contained in each piece of program data 3. Each piece of program data 3 indicates a broadcast time period 4 of the program, a broadcast station 5 for broadcasting the program, and a program description 6. A program guide display apparatus in a related art reads the broadcast time periods 4, the broadcast stations 5, and the program descriptions 6 contained in the program data, and displays a program guide of the broadcast programs.

FIG. 23 is a drawing to show a program guide 7 displayed by the program guide display apparatus in the related art. The program guide 7 indicates program descriptions 6aa to 6cc of programs, and the program descriptions 6aa to 6cc are arranged in order in a first direction 8 and a second direction 9 crossing the first direction 8. The program descriptions 6aa to 6cc are arranged contiguously in the first direction 8 for each of broadcast stations 5A to 5C, and the program descriptions of the broadcast programs from the same broadcast station are arranged contiguously in the second direction 9 in time sequence. For example, the program descriptions 6aa, 6ba, 6ca of the broadcast programs from the same A broadcast station 5A are arranged in a line in the second direction 9 in the ascending order of broadcast times 4A to 4C, and the program descriptions 6aa, 6ab, and 6ac of the broadcast programs from the broadcast stations in the same time period 4A are arranged in a row in the first direction 8 in a predetermined broadcast station order of 5A, 5B, and 5C.

In digital broadcasts, a plurality of programs are multiplexed on one broadcast wave and are broadcast; programs from a larger number of broadcast stations are broadcast as compared with conventional analog broadcasts. Accordingly, the number of programs that can be viewed by viewers increases and all programs that can be viewed may be unable to be displayed one screen as a program guide.

The program guide display apparatus in the related art displays the program descriptions in a predetermined display order and as the operator scrolls the display images, displays the descriptions of the programs broadcast from broadcast stations. Therefore, when the operator compares the descriptions of two different programs, if the display positions of the descriptions of the two programs are distant from each other, the operator cannot compare them on one screen; this is a problem. In this case, the operator needs to memorize the description of one of the two programs to be compared and scroll the display image to compare the description with the description of the other and cannot easily compare the two program descriptions on the display; this is a problem.

If a program description is not displayed on the display screen, the operator needs to scroll the display screen each time to check the program description and cannot easily check the program description; this is a problem.

JP-A-2001-16519 discloses another program guide display apparatus different from the program guide display apparatus in the related art described above. The program guide display apparatus arranges the programs in the time period selected out of a time period selection screen. A program guide display apparatus disclosed in JP-A-2001-8119 displays a program guide integrating program data of a plurality of information providing systems. A program guide display apparatus disclosed in JP-A-2000-333085 displays a program guide arranging the programs assigned the highest priority for each time period according to a predetermined priority.

If the operator does not predetermine the program to be viewed or the program to be selected, he or she compares program descriptions before determining the program to be viewed or selected. Each of the program guide display apparatus disclosed in the gazettes described above displays the program guide arranging the descriptions of the selected programs and thus the program descriptions are not displayed for each time period and not displayed for each broadcast station. Therefore, if the operator sees the displayed program guide, he or she cannot compare the program descriptions for each broadcast station or for each time period; this is a problem. The display order cannot be changed so that the two program descriptions to be compared are made contiguous; this is also a problem.

### SUMMARY OF THE INVENTION

It is therefore an object of the invention to provide a program guide display apparatus for displaying a program guide for enabling the operator to easily compare the program descriptions to be checked.

According to a first aspect of the invention, a program guide display apparatus includes a memory, a display unit, an input unit, and an order change unit. The memory stores a plurality of pieces of program data containing program descriptions of programs broadcast from broadcast stations and time periods at which the programs are broadcast. The display unit has a two-dimensional display screen for displaying the program descriptions in a table format in which the program descriptions are arranged in a first direction and in a second direction crossing the first direction. The input unit outputs a command from an operator as a command signal. The order change unit reads the program data stored in the memory and controlling the display unit to change an order of display positions of the program descriptions displayed in the table format in response to the command signal.

In the first aspect, when program data is stored in the memory, the program descriptions of programs are arranged in the first direction and the second direction for display on the display screen based on the program descriptions and the broadcast time periods of the programs indicated by the program data. The order of the display positions of the program descriptions displayed in the table format is changed in response to the command signal output by the input unit. Accordingly, the program descriptions can be displayed in the display order responsive to the operator's liking and the convenience of the operator can be improved. For example, the program descriptions of the programs of the broadcast station to be checked by the operator can be placed at positions of the display screen where the operator can easily see the program descriptions. For example, the two program descriptions to be compared can be displayed in one screen so that they are contiguous.

According to a second aspect of the invention, the program guide display apparatus of the first aspect further includes a reception unit for receiving a digital broadcasting including the program data. The memory stores the program data received by the reception unit.

In the second aspect, a digital broadcast is received by the reception unit, the received program data is stored in the memory, and the display unit displays the program descriptions in a table format based on the program data stored in the memory. The program data contained in the digital broadcast is updated to new program data whenever necessary. Therefore, the most recent program data can be stored in the memory as compared with the case where the program data is read from the storage medium previously storing the program data. The operator need not take possession of the storage medium storing the program data, and the program data can be easily stored in the memory.

According to a third aspect of the invention, in the table format, the display positions of the program descriptions are arranged contiguously in the first direction for each of broadcast stations and are arranged contiguously in the second direction for each of time periods. The order change unit changes the order of the display positions of the program descriptions arranged contiguously in the second direction in response to the command signal.

In the third aspect, the order change unit changes the order in which the program descriptions displayed in the table format are arranged in the second direction. Accordingly, the order of the program descriptions arranged for each time period on the display can be changed and the convenience of the operator can be improved. For example, the program descriptions of the programs in the time period to be viewed by the operator can be collectively displayed at positions of the display screen where the operator can easily see the program descriptions. For example, the order of the program descriptions displayed for each time period maybe changed for each broadcast station separately or may be changed for a plurality of broadcast stations collectively.

According to a fourth aspect of the invention, in the table format, the display positions of the program descriptions are arranged contiguously in the first direction for each of broadcast stations and are arranged contiguously in the second direction for each of time periods. The order change unit changes the order of the display positions of the program descriptions in the first direction for each of the broadcast stations in response to the command signal.

In the fourth aspect, the order change unit changes the order in which the program descriptions displayed in the table format are arranged along the first direction for each broadcast station. Accordingly, the order of the program descriptions of the programs broadcast from the same broadcast station can be changed along the first direction for each broadcast station, and the convenience of the operator can be improved. For example, the program descriptions of the programs of the broadcast station to be viewed by the operator can be collectively displayed at positions of the display screen where the operator can easily see the program descriptions. The two program descriptions of the broadcast station to be compared by the operator can be displayed contiguously.

According to a fifth aspect of the invention, in the table format, the display positions of the program descriptions are arranged contiguously in the first direction for each of broadcast stations and are arranged contiguously in the second direction for each of time periods. The order change unit changes the order of the display positions of the program descriptions arranged contiguously in the first direction.

In the fifth aspect, the order change unit changes the order in which the program descriptions displayed in the table format are arranged contiguously in the first direction. Accordingly, the order of the program descriptions arranged for each broadcast station on the display can be changed and the convenience of the operator can be improved. For example, the program descriptions of the programs in the time period to be viewed by the operator can be arranged in a row regardless of the broadcast stations. The order of the program descriptions displayed for each broadcast station maybe changed for each time period separately or maybe changed for a plurality of time periods collectively.

According to a sixth aspect of the invention, the program guide display apparatus of the first aspect, further includes a program description copy unit for copying at least one of the program descriptions in response to the command signal. The order change unit sets a copy display position where the copied program description is displayed, separately from the display positions. The order change unit controls the display unit to display the copied program description contiguous to the program descriptions.

In the sixth aspect, the program description copied by the program description copy unit is displayed at the copy display position set aside from the display position. Accordingly, the copied program description and the program descriptions displayed in the table format can be arranged in one display screen and the convenience of the operator can be improved. For example, the operator can compare the copied program description with any other program description in one screen and the program descriptions of the two programs to be checked by the operator can be displayed at the same time.

According to a seventh aspect of the invention, the program guide display apparatus of the first aspect further includes a first selection unit, a broadcast time retrieval unit, and a time arrival signal output unit. The first selection unit allows a user to select at least one of the programs. The broadcast time retrieval unit retrieves broadcast time of the selected program on the basis of the program data stored in the memory. The time arrival signal output unit outputs a time arrival signal indicating that the broadcast time of the selected program comes, when the retrieved broadcast time comes.

In the seventh aspect, the broadcast time of the selected program is retrieved and when the broadcast time is reached, the time arrival signal indicating that the broadcast time of the selected program is reached is output. The time arrival signal is used as a signal for recording or displaying a program, whereby the selected program can be preselected.

As the operator selects a program with the program descriptions displayed in the table format, the operator can select a program while checking the program descriptions. The table format can be displayed matching the operator's liking and the program descriptions to be checked by the operator are displayed in one screen, thereby enabling the operator to easily select a program.

According to an eighth aspect of the invention, the program guide display apparatus of the seventh aspect, further includes a record unit for recording at least one of video and audio of the selected program in response to the time arrival signal output from the time arrival signal output unit.

In the eighth aspect, the record unit stores at least either of video and audio of the selected program so that the video or audio of the program can be played back in response to the time arrival signal. The operator can check the program to be recorded while checking the display screen, and can set the program to be selected. At this time, the program descriptions of the programs to be selected can be displayed in one screen in the table format matched with the operator's liking as described above, thus enabling the operator to easily select the program to be recorded.

According to a ninth aspect of the invention, the order change unit sets an additional display position where the selected program description is displayed, separately from the display positions. The order change unit controls the display unit to display the selected program description contiguous to the program descriptions.

In the ninth aspect, the program description of the selected program is set aside from the display position and is displayed as an added display position, whereby the program description of the selected program can be added to the display screen and the convenience of the operator can be improved. Since the program description of the selected program and other program descriptions can be displayed in one screen, the program descriptions of other programs in the broadcast time period of the selected program can be displayed for each broadcast station.

According to a tenth aspect of the invention, the order change unit controls the display unit to display the program description of the selected program in a different mode from that of the program descriptions of the other programs.

In the tenth aspect, the display area displaying the program description of the selected program and the display area displaying the program description of an unselected program are displayed in different display modes. This enables the operator to distinguish the selected programs from other programs in the program descriptions displayed in the table format and reliably understand the already selected program. The different display modes may be different display colors, different fonts, etc., in the areas displaying the program descriptions, for example. A symbol indicating selection may be added to the display area displaying the selected program description for display.

According to an eleventh aspect of the invention, the program guide display apparatus of the seventh aspect, further includes a count unit for counting number of times that programs, which are at least similar to each other and are broadcast at a predetermined interval, have been selected, and a second selection unit for estimating and selecting a future program, which is similar to the similar programs and will be broadcast in the future, when the counted number is not smaller than a predetermined value.

In the eleventh aspect, when the programs having the same or similar program description among the selected programs in the same or similar time period every day have been selected the predetermined number of times or more, the next same or similar program to be selected is estimated and selected. Accordingly, the program broadcast serially every week, such as a serial drama, can be selected without the need for the operator to select the program. For example, the program guide display apparatus may record the estimated program. The same program descriptions may be the same program titles, for example, and the similar program descriptions may be similar broadcast program descriptions, for example.

According to a twelfth aspect of the invention, the order change unit controls the display unit to display the program description of the estimated and selected program in a different mode from that of the program descriptions of the other programs.

In the twelfth aspect, the display area displaying the program description of an estimated and selected program and the display area displaying the program description of a selected program without being estimated are displayed in different display modes, so that whether the program is a program selected by the operator or a program estimated and selected by the program guide display apparatus can be indicated on the display screen.

### BRIEF DESCRIPTION OF THE DRAWINGS

In the accompanying drawings:

FIG. 1 is a block diagram to show a program guide display apparatus 20 of one embodiment of the invention;

FIG. 2 is a front view to show a display 23;

FIG. 3 is a drawing to show a procedure of changing the display order of program descriptions arranged for each time period;

FIG. 4 is a flowchart to show the operation of a CPU 35 for changing the display order of program descriptions arranged for each time period;

FIG. 5 is a drawing to show a procedure of changing the display order of program descriptions arranged for each broadcast station;

FIG. 6 is a flowchart to show the operation of the CPU 35 for changing the display order of program descriptions arranged for each broadcast station;

FIG. 7 is a drawing to show a procedure of changing the broadcast station arranging order;

FIG. 8 is a flowchart to show the operation of the CPU 35 for changing the broadcast station arranging order;

FIG. 9 is a drawing to show a procedure of further changing the program description arranging order for each time period in a state in which the program description arranging order for each broadcast station is changed;

FIG. 10 is a drawing to show a procedure of copying program descriptions and adding the program descriptions to a table format for display;

FIG. 11 is a flowchart to show the operation of the CPU 35 for copying program descriptions and adding the program descriptions to a table format for display;

FIG. 12 is a flowchart to show the operation of the CPU 35 for changing the order in a program guide;

FIG. 13 is a flowchart to show the operation of the CPU 35 for storing a selected program;

FIG. 14 is a flowchart to show the operation of the CPU 35 for recording a selected program;

FIG. 15 is a drawing to show a part of the table format displayed with a selected program stored in RAM 37;

FIG. 16 is a drawing to show a part of the table format when the image is scrolled from the state shown in FIG. 15;

FIG. 17 is a drawing to show an image represented by the image data stored in expansion processing VRAM 56;

FIG. 18 is a flowchart to show the operation of the CPU 35 for selecting selected programs based on a selection history;

FIG. 19 is a drawing to show a program guide collecting selected programs;

FIG. 20 is a drawing to show a part of a table format to show another display example;

FIG. 21 is a drawing to show a broadcast wave of digital broadcasting;

FIG. 22 is a drawing to show a data structure contained in each piece of program data 3; and FIG. 23 is a drawing to show a program guide 7 displayed by a program guide display apparatus in a related art.

### DETAILED DESCRIPTION OF THE PREFERRED EMBODIMENTS

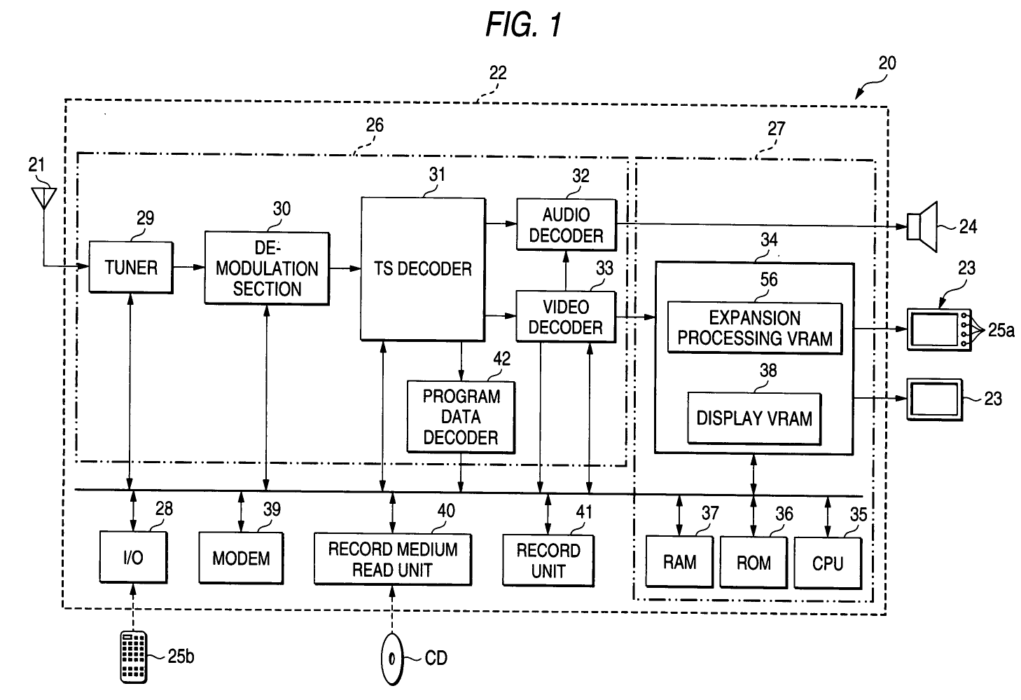

FIG. 1 is a block diagram to show a program guide display apparatus 20 of one embodiment of the invention. The program guide display apparatus 20 receives digital broadcasts, extracts program data contained in the digital broadcasts, and displays the descriptions of the programs of digital broadcasting from the extracted program data as a program guide. The program guide display apparatus 20 displays the program guide so as to enable the user to change the display order of the program descriptions in the program guide.

The program data indicates the broadcast time period of each program, the broadcast station broadcasting the program, and the description of the program. The program description contains information of the program title, category, performers, plot, and the like. The program guide is displayed in a table format in which program descriptions are arranged contiguously in a first direction and a second direction crossing the first direction.

The program guide display apparatus 20 implements a digital broadcast television receiver, which extracts video data and audio data of each digital broadcast program, synchronizes the video and audio based on the extracted video data and audio data, and displays the video of the program and produces the audio of the program.

The program guide display apparatus 20 has an antenna 21 for capturing digital broadcast waves transmitted from a broadcast satellite and a ground antenna, a display 23 of display unit having a two-dimensional display screen for displaying an image, a loudspeaker 24, a display controller 22 for extracting program data from the digital broadcast waves and displaying a program guide on the display 23, and switches 25a and 25b for sending operator commands to the display controller 22. The switches 25a and 25b are display switches 25a placed at positions close to the display 23 and remote control switches 25b placed on a remote control that can conduct radio communications with the display controller 22.

The display controller 22 includes reception unit 26 for receiving program data, control unit 27 for controlling the display 23 so as to display a program guide, and input unit 28 for outputting a command signal responsive to operation of each of the switches 25a, 25b by the operator to the control unit 27.

The reception unit 26 has a tuner 29 for selecting and receiving the digital broadcast wave of one channel from among the digital broadcast waves captured through the antenna 21, a demodulation section 30 for demodulating the digital broadcast wave of the channel selected, a transport stream (TS) decoder 31 for extracting a signal containing program data from the signal provided by the demodulation section 30, and a program data decoder 42 for generating program data from the signal containing program data.

The reception unit 26 further has an audio decoder 32 for generating audio data from the program signal and a video decoder 33 for generating image data from the program signal to display and produce video and audio of digital broadcast program.

The control unit 27 has a central processing unit (CPU) 35 for performing control concerning display of the display 23, read-only memory (ROM) 36 previously storing a display program concerning display of the display 23, random access memory (RAM) 37 for writing the computation result of the CPU 35 and reading the written computation result, and a presentation processing section 34 for receiving a signal concerning display output from the CPU 35 and controlling the display 23. The RAM 37 stores program data and display order data indicating the program description display order.

The presentation processing section 34 is provided with display VRAM (video random access memory) 38 for storing one-screen image data to display on the display 23 and expansion processing VRAM 56 for storing expansion processing image data indicating image data for displaying all program descriptions in a table format according to the display order data. The presentation processing section 34 reads the image data from the display VRAM 38 and displays a one-screen image on the display 23.

The switches 25a and 25b are connected to the input unit 28. The input unit 28 is an interface for sending an operator command to the control unit 27. When the operator operates any of the switches 25a, 25b, the input unit 28 outputs a command signal responsive to the operator command to the control unit 27.

The display controller 22 further has a communication modem 39 for connecting to a telephone communication line and can access a network connected to the telephone communication line, such as the Internet. The display controller 22 further has record unit 41 implemented as a harddisk, etc., for recording the received image data and audio data.

When the operator operates one of the switches 25a, 25b to give a command for displaying a program guide, the input unit 28 outputs a program guide display command signal for giving a command for displaying a program guide to the control unit 27. Upon reception of the program guided is play command signal, the control unit 27 gives the program guide display command signal to the reception unit 26 so as to generate program data.

The TS decoder 31 of the reception unit 26 extracts a signal containing program data from the signal provided by the demodulation section 30 and gives the signal containing program data to the program data decoder 42, which then generates program data from the signal containing program data. The RAM 37 stores a plurality of pieces of the program data generated by the program data decoder 42 without processing the program data.

The CPU 35 reads the program data and the display order data from the RAM 37. The CPU 35 determines the display positions of program descriptions according to the display order data, prepares expansion processing image data indicating the program descriptions in a table format, and stores the prepared expansion processing image data in the expansion processing VRAM 56.

The presentation processing section 34 reads the expansion processing image data stored in the expansion processing VRAM 56, writes one-display-screen image data in the expansion processing image data into the display VRAM 38, and displays a one-screen program guide on the display 23.

As the operator operates any of the switches 25a, 26b so as to change the display order of the program descriptions, the input unit 28 outputs a command signal for changing the display order to the control unit 27. The CPU 35 of the control unit 27 updates the display order data stored in the RAM 37 and rewrites new expansion processing image data into the expansion processing VRAM 56.

The program guide display apparatus 20 receives a broadcast program and displays the image of the program and produces audio as a television receiver. Specifically, when the operator operates one of the switches 25a, 25b to give a command for displaying a program, the input unit 28 outputs a program display command signal for giving a command for displaying a program to the control unit 27. Upon reception of the program display command signal, the control unit 27 gives the program display command signal to the reception unit 26 so as to generate image data and audio data.

The tuner 29 of the reception unit 26 receives the digital broadcast wave containing the program to be displayed from the broadcast waves captured through the antenna 21 and gives the received digital broadcast wave to the demodulation section 30. The demodulation section 30 demodulates the digital broadcast wave given from the tuner 29 and gives the demodulated signal to the TS decoder 31. The TS decoder 31 extracts the program signal of the program to be displayed and gives the program signal to the audio decoder 32 and the video decoder 33. The video decoder 33 generates video data from the program signal and the audio decoder 32 generates audio data from the program signal.

The presentation processing section 34 of the control unit 27 receives the image data generated by the video decoder 33 and the audio data generated by the audio decoder 32. The presentation processing section 34 stored one-screen image data in the display VRAM 38 and displays an image on the display 23 so as to synchronize the image and audio of the program. The loudspeaker 24 receives the audio data from the audio decoder 32 and produces audio.

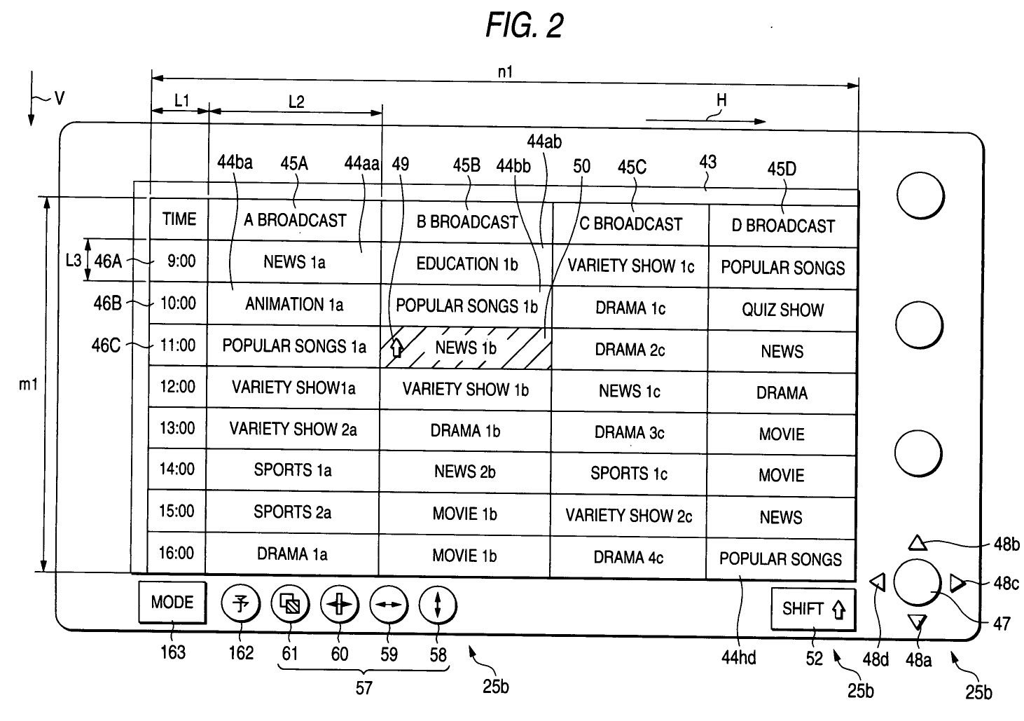

FIG. 2 is a front view to show the display 23. The display 23 displays the descriptions of programs in a table format. The descriptions of programs are displayed in program description display areas 44aa to 44hd provided in a one-to-one correspondence with programs. In FIG. 2, for easy understanding, some of suffixes aa to hd of the program description display areas 44aa to 44hd are omitted.

The display 23 displays the program descriptions contiguously in a main scanning direction H for each broadcast station and displays the program descriptions contiguously in a subscanning direction V for each broadcast time period. The display 23 arranges the categories of the broadcast programs for each broadcast station and for each time period in the program description display areas 44aa to 44hd. The time periods are divided in one-hour units, for example.

Information of any of the program name, plot, or performers of each broadcast program other than the category of the broadcast program may be displayed in the program description display areas 44aa to 44hd. The time period of the programs displayed in the program description display areas 44aa to 44hd may be a predetermined time period; the time periods may be divided in 30-minute units.

The display 23 displays time period display areas 46A to 46C for displaying the time periods broadcasting the programs and broadcast station display areas 45A to 45D for displaying the broadcast stations broadcasting the programs in addition to the program description display areas 44aa to 44hd. The time period display areas 46A to 46C and the broadcast station display areas 45A to 45D are arranged at the positions corresponding to the program descriptions in the program description display areas 44aa to 44hd.

For example, the time period display areas 46A to 46C are displayed contiguously in one column in the subscanning direction V in time sequence, and the broadcast station display areas 45A to 45D are displayed continuously in one row in the main scanning direction H in a predetermined order.

The CPU 35 determines the main scanning and subscanning direction dimensions of the program description display areas 44aa to 44hd in response to the broadcast time periods, titles, and descriptions of programs, and displays the program description display areas 44aa to 44hd as rectangles of the same dimensions. The main scanning direction dimensions of the program description display areas 44aa to 44hd and the broadcast station display areas 45A to 45D are formed each as the same dimension L2. The subscanning direction dimensions of the program description display areas 44aa to 44hd and the time period display areas 46A to 46C are formed each as the same dimension L3.

The switches 25b for changing the display order in the program guide are placed in the vicinity of a display screen 43 of the display 23. The switches 25b are cursor move keys 48 for moving a cursor 49 displayed on the display screen 43, a determination key 47 for determining programs, and an order change key 52 for changing the display order of program descriptions of the determined programs. The switches 25b further include order pattern selection keys 57 each for specifying an order change pattern of program descriptions and a preselection key 162 for timer-recording a preselected program. The order pattern selection keys 57 are made up of switches 58 to 61 each for specifying a display order change pattern of program descriptions (described later).

The cursor move keys 48 include a first move key 48a for moving the cursor 49 to one side in the subscanning direction V, a second move key 48b for moving the cursor 49 to an opposite side in the subscanning direction V, a third move key 48c for moving the cursor 49 to one side in the main scanning direction H, and a fourth move key 48d for moving the cursor 49 to an opposite side in the main scanning direction H.

The display 23 displays the cursor 49 so that the cursor 49 moves on the program description display areas 44aa to 44hd displayed in the table format in response to operation of the first to fourth move keys 48a to 48d. The display 23 changes the display mode of the program description display area 44cb, which is a portion on which the cursor 49 is displayed (indicated by a hatched area 50 in FIG. 2).

The operator moves the cursor 49 by operating the cursor move key 48 for selecting the program description display area displaying the program description whose display order is to be changed and then presses the determination key 47, thereby determining the program whose display order is to be changed. The input unit 28 outputs a signal indicating the program selected by moving the cursor to the CPU 35.

As the operator continues to operate the first to fourth move keys 48a to 48d, the cursor 49 moves in the main scanning direction H and the subscanning direction V and the display image is scrolled in the direction corresponding to each of the move keys 48a to 48d. As the display image is scrolled, the program descriptions beyond one screen are displayed.

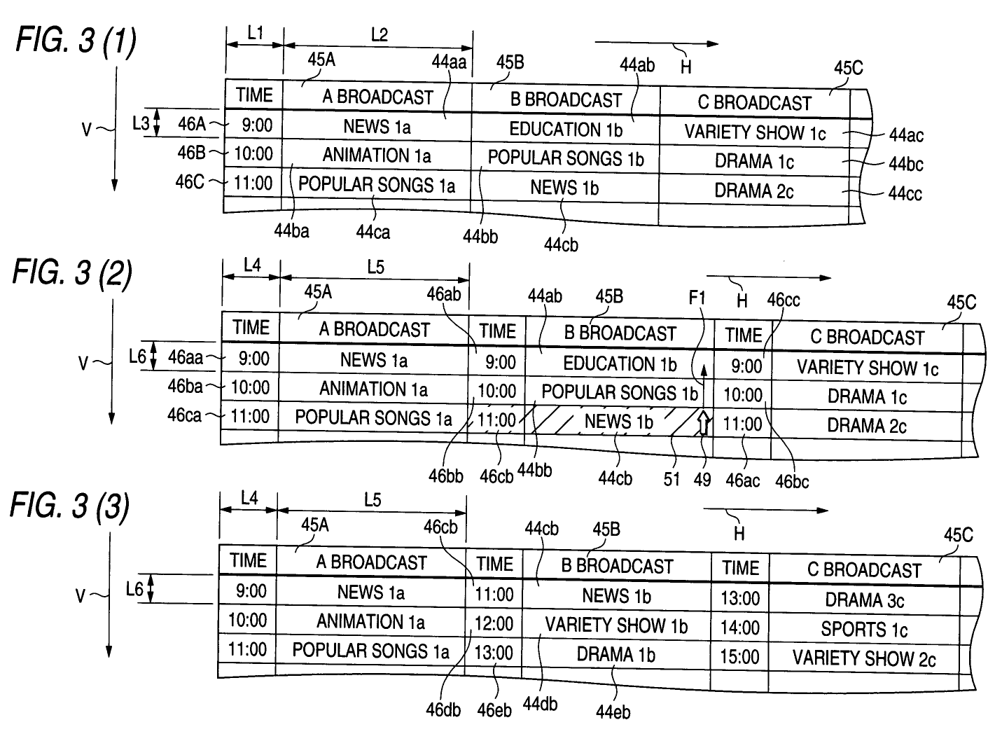

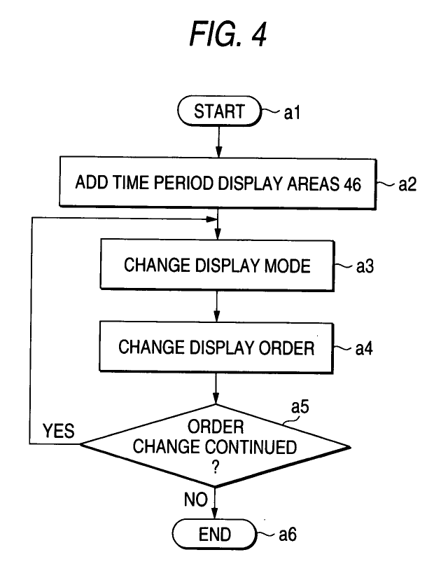

FIG. 3 is a drawing to show a procedure of changing the display order of program descriptions arranged for each time period. The operation advances in the order of FIG. 3(1) to FIG. 3(3). FIG. 4 is a flowchart to show the operation of the CPU 35 for changing the display order of program descriptions arranged for each time period. To change the display order of program descriptions arranged for each time period, the CPU 35 serves as an order change unit for changing the order of the display positions of program descriptions arranged in the subscanning direction V by executing a program stored in the ROM 36.

At step a1, the CPU 35 controls the display 23 so as to display program descriptions in the program description display areas 44aa to 44cc in the table format responsive to the display order stored in the expansion processing VRAM 56. For example, as shown in FIG. 3(1), the CPU 35 displays the descriptions of programs broadcast in the same time period for each broadcast station contiguous in the main scanning direction and the descriptions of programs broadcast from the same broadcast station contiguous in the subscanning direction V in time sequence.

Next, as the operator presses the order pattern selection switch 58 for changing the order of program descriptions for each time period, the input unit 28 outputs a command signal for changing the order of program descriptions in the subscanning direction V to the CPU 35. Upon reception of the signal from the input unit 28, the CPU 35 goes to step a2 and starts the order change operation of program descriptions.

At step a2, time period display areas 46aa to 46cc provided in a one-to-one correspondence with the program description display areas 44aa to 44cc are displayed. The CPU 35 controls the display 32 so that the time period display areas 46aa, 46ba, 46ca; 46ab, 46bb, 46cb; and 46ac, 46bc, 46cc extended along the subscanning direction V are displayed contiguous to the program description display areas 44aa to 44cc, as shown in FIG. 3(2). The CPU 35 displays the time periods, at which the programs corresponding to the program descriptions displayed in the program description display areas 44aa to 44cc contiguous to the time period display areas 46aa to 46cc are broadcast, in the time period display areas 46aa to 46cc. Upon completion of adding the time period display areas 46aa to 46cc provided in a one-to-one correspondence with the programs, the CPU 35 goes to step a3.

At step a3, the cursor 49 is moved in response to an output signal of the input unit 28 based on switch operation of the operator. After the cursor 49 is moved to the program description display area 44cb selected by the operator, if the operator presses the determination key 47, the CPU 35 receives a signal indicating the selected program from the input unit 28, sets the program description display area 44cb displaying the program description of the program selected by the operator and its corresponding time period display area 46cb as a selection area 51, and controls the display 23 so as to change the display mode of the area and then goes to step a4.

At a4, the operator operates the move key 48 with the order change key 52 pressed. The CPU 35 updates the display order data in response to an output signal of the input unit 28 and changes the display position order for displaying the program description and the time period displayed in the selection area 51 in the subscanning direction V.

For example, if the operator operates the move key 48 so as to move the cursor 49 in the subscanning direction V indicated by an arrow F1 in FIG. 3(2) after selecting the selection area 51, the program description and the time period displayed in the selection area 51 are displayed in the program description display area and the time period display area in the arrow F1 direction. Upon completion of changing the display order, the CPU 35 goes to step a5.

At step a5, the CPU 35 determines whether or not order change is continued. If the CPU determines that order change is continued, it returns to step a3 and again performs the order change operation. As the order change operation is performed more than once, the program descriptions of the programs broadcast in different time periods can be displayed as the program descriptions arranged in the main scanning direction H, as shown in FIG. 3(3). Upon completion of the order change operation at step a5, the CPU 35 goes to step a6 and terminates the operation.

For example, at step a2, the dimensions of each of the display areas 44aa to 44cc, 45A to 45C, and 46A to 46D may be changed for display and may be set to dimensions for enabling the user to easily see the display in response to additional display of the time period display areas 46aa to 46cc. For example, the sum (L4+L5) of main scanning direction H dimension L5 of each of the program description display areas 44aa to 44cc and main scanning direction H dimension L4 of each of the time period display areas 46A to 46C at step a2 may be made smaller than the main scanning direction dimension L2 of each of the program description display areas 44aa to 44cc at step a1 so as to prevent lessening of the number of program descriptions that can be displayed in one screen if the time period display areas 46aa to 46cc are added for display.

At step a4, in the program description order change, the program description and the time period of each of the display areas 44ab, 44bb, and 44cb; and 46ab, 46bb, and 46cb displayed in a column in the subscanning direction V containing the selection area 51 may be slid in the subscanning direction V, as shown in FIG. 3(3). The program description and the time period displayed in the selection area 51 selected may be extracted and moved in the subscanning direction V.

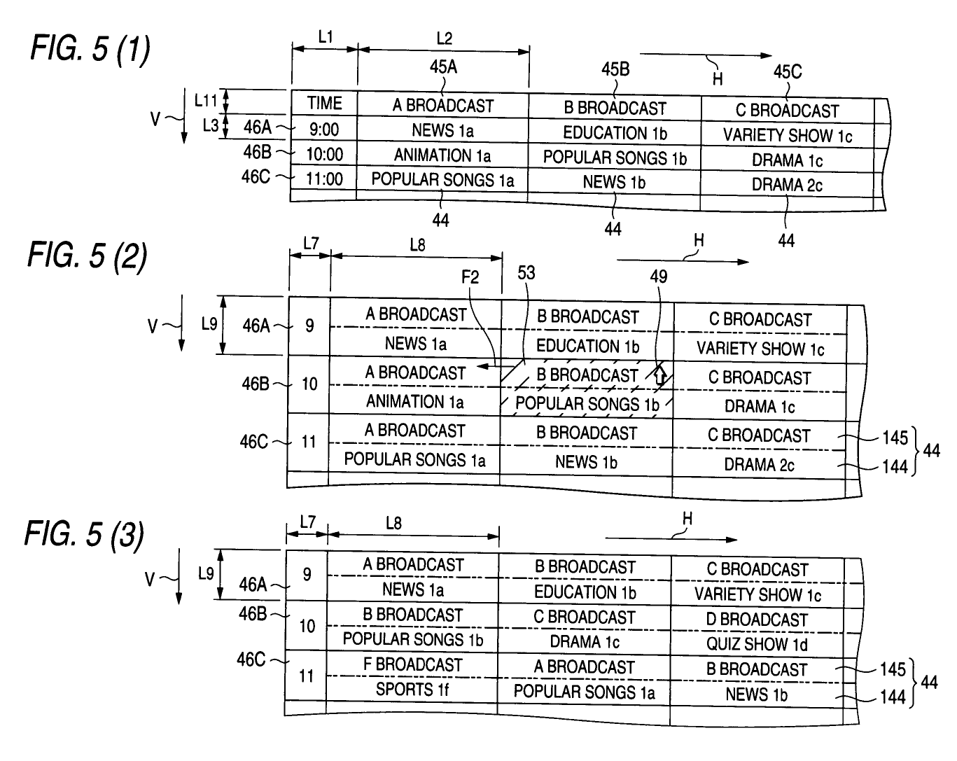

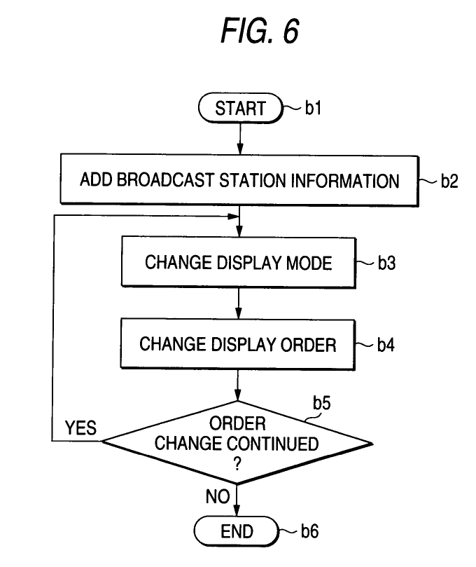

FIG. 5 is a drawing to show a procedure of changing the display order of program descriptions arranged for each broadcast station. The operation advances in the order of FIG. 5(1) to FIG. 5(3). FIG. 6 is a flowchart to show the operation of the CPU 35 for changing the display order of program descriptions arranged for each broadcast station. To change the display order of program descriptions arranged for each broadcast station, the CPU 35 serves as an order change unit for changing the order of the display positions of program descriptions arranged in the main scanning direction H by executing a program stored in the ROM 36. In the description that follows, for easy understanding, suffixes of the program description display areas 44aa to 44cc displaying the program descriptions of program may be omitted.

At step b1, as at step a1, the CPU 35 controls the display 23 so as to display program descriptions in the program description display areas 44 in a predetermined table format as shown in FIG. 5(1).

Next, as the operator presses the order pattern selection switch 59 for changing the order of program descriptions for each broadcast station, the input unit 28 outputs a command signal for changing the order of program descriptions in the main scanning direction H to the CPU 35. Upon reception of the signal from the input unit 28, the CPU 35 goes to step b2 and starts the order change operation of program descriptions.

At step b2, the broadcast station display areas 45A, 45B, and 45C are deleted and each broadcast station name is contained in each program description display area for display. For example, as shown in FIG. 5 (2) , each program description display area 44 may be further divided into two areas so as to display the broadcast station name in one area 145 and the program description in the other area 144. Upon completion of display, the CPU 35 goes to step b3.

At step b3, the cursor 49 is moved in response to an output signal of the input unit 28 based on switch operation of the operator. After the cursor 49 is moved to the program description display area selected by the operator, if the operator presses the determination key 47, the CPU 35 sets the program description display area selected by the operator as a selection area 53 and changes the display mode of the area and then goes to step b4.

At b4, the operator operates the move key 48 with the order change key 52 pressed. The CPU 35 updates the display order data in response to an output signal of the input unit 28 and changes the display position order for displaying the program description and the broadcast station name displayed in the selection area 53 in the main scanning direction H.

For example, if the operator operates the move key so as to move the cursor 49 in the main scanning direction H indicated by an arrow F2 in FIG. 5(2) after selecting the selection area 53, the program description and the broadcast station name displayed in the selection area 53 are displayed in the program description display area in the arrow F2 direction. Upon completion of changing the display order, the CPU 35 goes to step b5.

At step b5, the CPU 35 determines whether or not order change is continued. If the CPU determines that order change is continued, it returns to step b3 and again performs the order change operation. As the order change operation is performed more than once, the program descriptions of the programs broadcast from different broadcast stations can be displayed as the program descriptions arranged in the subscanning direction V, as shown in FIG. 5(3). Upon completion of the order change operation at step b5, the CPU 35 goes to step b6 and terminates the operation.

For example, at step b2, the dimensions of each of the display areas 44, 45A to 45C, and 46A to 46C may be changed and may be set to dimensions for enabling the user to easily see the display in response to addition of the broadcast station names displayed in the program description display areas 44. Specifically, either of the main scanning and subscanning dimensions L2 and L3 of each of the program description display areas displayed at step b1 is enlarged to form main scanning and subscanning dimensions L8 and L9 of each of the program description display areas displayed at step b2, so that if the broadcast station name is displayed in each program description display area, the display can be made easy to see without reducing the program description.

At step b4, in the program description order change, the program description and the broadcast station name displayed in each of the program description display areas displayed in a row in the main scanning direction H containing the selection area 53 may be slid in the main scanning direction H, as shown in FIG. 5(3). The program description and the broadcast station name displayed in the selection area 53 may be extracted and moved in the main scanning direction H.

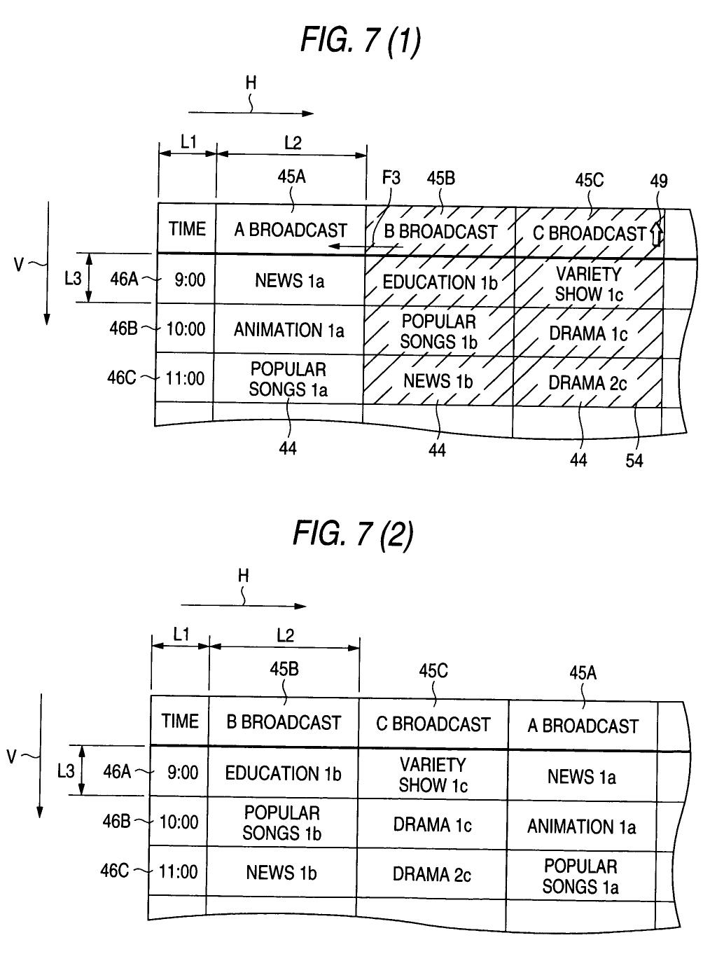

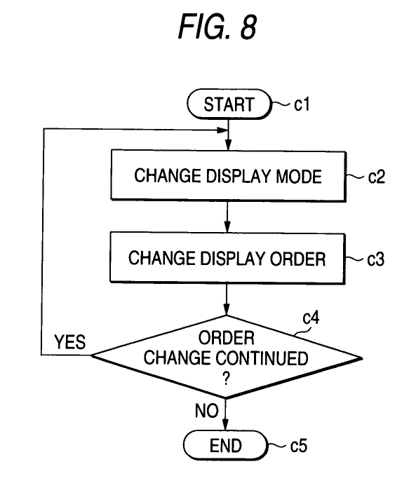

FIG. 7 is a drawing to show a procedure of changing the broadcast station arranging order. The operation advances in the order of FIG. 7(1) and FIG. 7(2). FIG. 8 is a flowchart to show the operation of the CPU 35 for changing the broadcast station arranging order. To change the broadcast station arranging order, the CPU 35 serves as an order change unit for changing the order of program descriptions displayed for each broadcast station along the main scanning direction H by executing a program stored in the ROM 36.

At step c1, as with the step al described above, the CPU 35 controls the display 23 so as to display program descriptions in the program description display areas 44 in a predetermined table format as shown in FIG. 7(1).

Next, as the operator presses the order pattern selection switch 60 for changing the broadcast station arranging order, the input unit 28 outputs a command signal for changing the order of program descriptions displayed for each broadcast station to the CPU 35. Upon reception of the signal from the input unit 28, the CPU 35 goes to step c2 and starts the order change operation of program descriptions.

At step c2, the cursor 49 is moved in response to an output signal of the input unit 28 based on switch operation of the operator. After the cursor 49 is moved to the program description display area selected by the operator, if the operator presses the determination key 47, the CPU 35 sets the program description display area selected by the operator as a selection area 54 and changes the display mode of the area and then goes to step c3. For example, the program description display areas for a plurality of broadcast stations may be collectively set as the selection area 54.

At c3, the operator operates the move key 48 with the order change key 52 pressed. The CPU 35 updates the display order data in response to an output signal of the input unit 28 and changes the display position order for displaying the program descriptions for each broadcast station displayed in the selection area 54, in the main scanning direction H.

For example, if the operator operates the move key so as to move the cursor 49 in the main scanning direction H indicated by an arrow F3 in FIG. 7(1) after selecting the selection area 54, the program descriptions displayed in the selection area 54 are displayed in the program description display areas in the arrow F3 direction. Upon completion of changing the display order, the CPU 35 goes to step c4.

At step c4, the CPU 35 determines whether or not order change is continued. If the CPU determines that order change is continued, it returns to step c2 and again performs the order change operation. Upon completion of the order change operation, the CPU 35 goes to step c5 and terminates the operation.

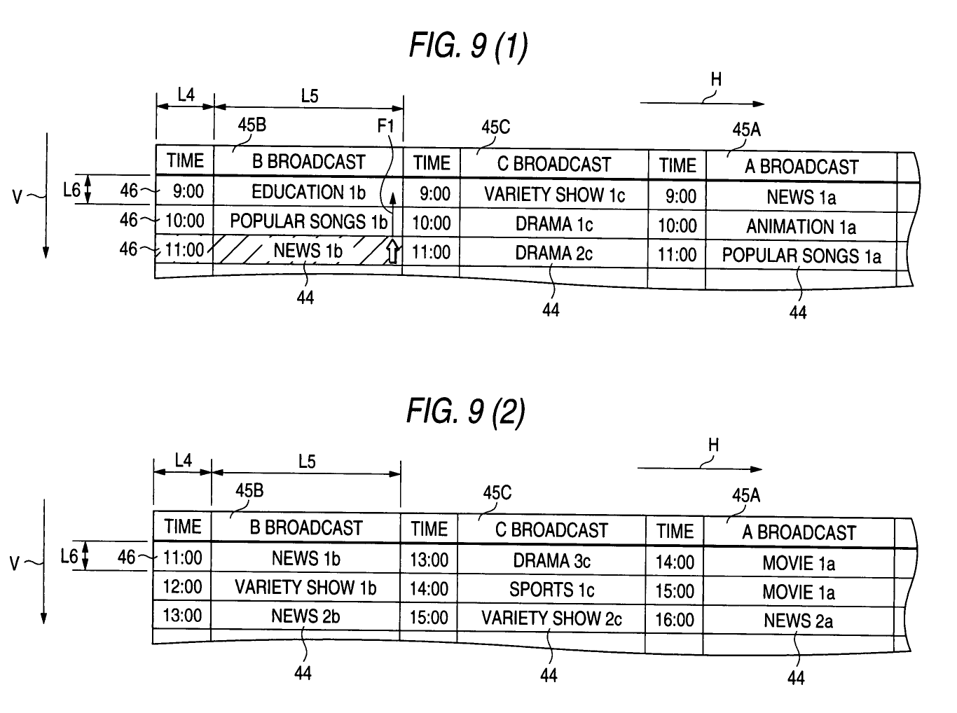

FIG. 9 is a drawing to show a procedure of further changing the program description arranging order for each time period in a state in which the program description arranging order for each broadcast station is changed. The CPU 35 changes the program description display order for each broadcast station as shown in FIG. 9(1) in accordance with the operation shown in the flowchart of FIG. 8 and then can further change the program description display order in the subscanning direction V as shown in FIG. 9(2) in accordance with the operation shown in the flowchart of FIG. 4. The details of the operation can be accomplished by combining the operation shown in FIG. 4 and the operation shown in FIG. 9 and will not be discussed again.

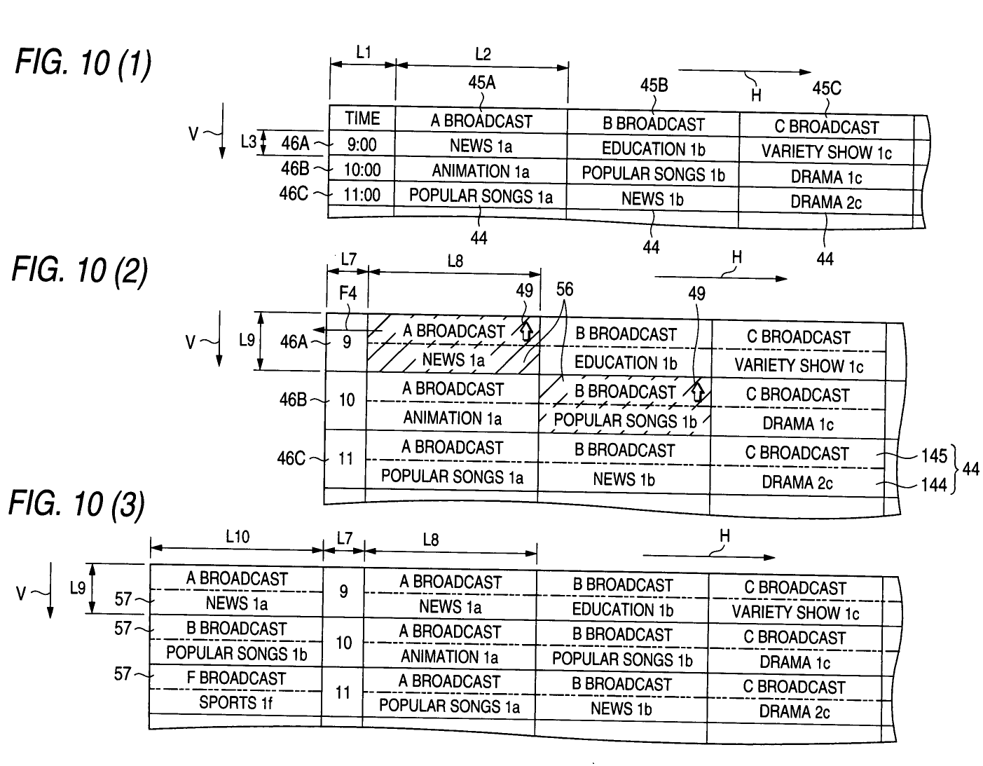

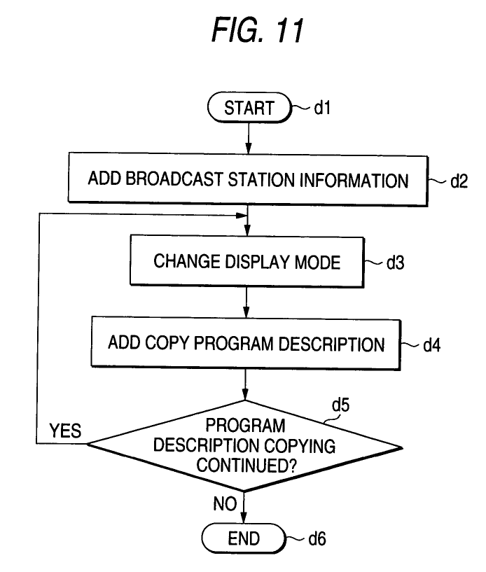

FIG. 10 is a drawing to show a procedure of copying program descriptions and adding the program descriptions to a table format for display. The operation advances in the order of FIGS. 10(1) to 10(3). FIG. 11 is a flowchart to show the operation of the CPU 35 for copying program descriptions and adding the program descriptions to a table format for display. The CPU 35 serves as a program description copy unit for copying program descriptions and adding the program descriptions to a table format for display by executing a program stored in the ROM 36.

At step d1, as with the above described steps, the CPU 35 controls the display 23 so as to display program descriptions in the program description display areas 44 in a predetermined table format as shown in FIG. 10(1).

Next, as the operator presses the order pattern selection switch 61 for copying program description, the input unit 28 outputs a command signal for copying program description to the CPU 35. Upon reception of the signal from the input unit 28, the CPU 35 goes to step d2 and starts the program description copy operation.

At step d2, the CPU 35 performs similar operation to that at step b2 shown in FIG. 6 and displays the broadcast station name and the program description in each program description display area. Upon completion of display, the CPU 35 goes to step d3.

At step d3, the cursor 49 is moved in response to an output signal of the input unit 28 based on switch operation of the operator. After the cursor 49 is moved to the program description display area selected by the operator, if the operator presses the determination key 47, the CPU 35 sets the program description display area selected by the operator as a selection area 56 and changes the display mode of the area and then goes to step d4.

At step d4, the operator operates the move key 48 with the order change key 52 pressed, as shown in FIG. 10 (2). The CPU 35 adds new copy display positions for displaying the program descriptions displayed in the selection area 56 to the table format and displays the program descriptions displayed in the selection area 56 at the copy display positions.

Specifically, the CPU 35 adds a copy program description display area 57 for displaying the selected program descriptions to one side end of the program format in the main scanning direction and displays the program descriptions displayed in the selection area 56 in the copy program description display area 57. Upon completion of the copy display, the CPU 35 goes to step d5.

At step d5, the CPU 35 determines whether or not program description copying is continued. If the CPU determines that program description copying is continued, it returns to step d3 and again performs the program description copying operation. Upon completion of the program description copying operation, the CPU 35 goes to step d6 and terminates the operation.

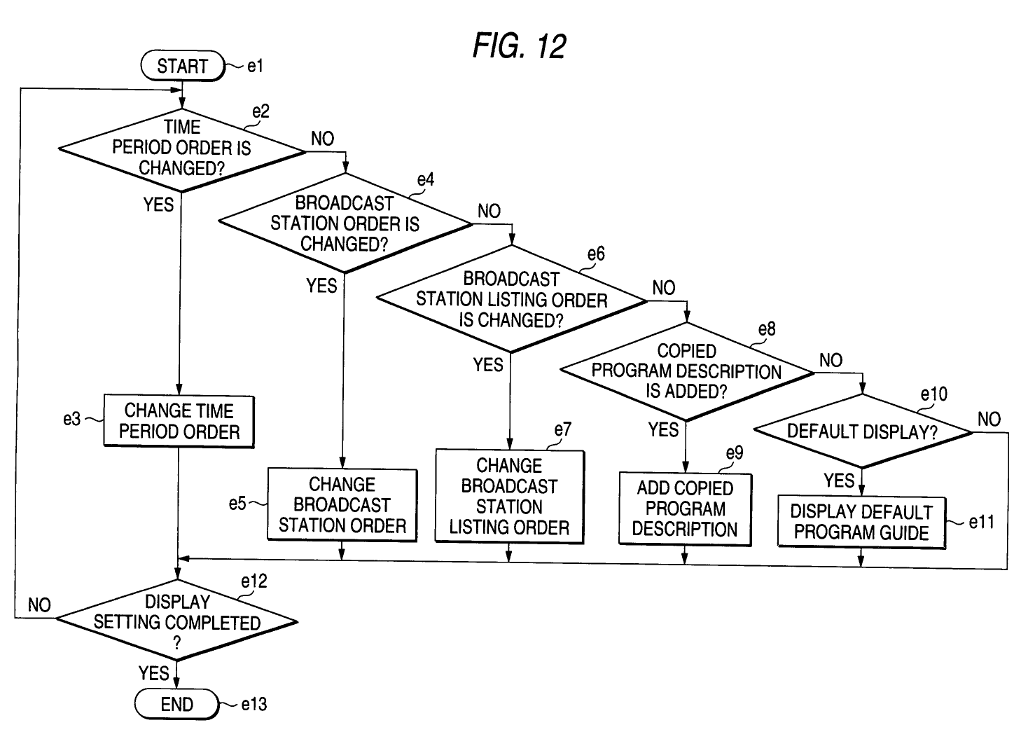

FIG. 12 is a flowchart to show the operation of the CPU 35 for changing the order in a program guide. The CPU 35 performs display control shown in FIGS. 3 to 11 in response to the output signal of the input unit 28 responsive to switch operation of the operator.

To begin with, the CPU 35 makes a transition to a state in which the order in a program guide can be changed at step e1 and goes to step e2 and starts the operation of changing the order in a program guide. At step e2, the CPU 35 determines whether or not the output signal from the input unit 28 is a command for changing the display order of the program descriptions arranged for each time period. If the output signal is a command for changing the time period order, the CPU 35 goes to step e3; otherwise, the CPU 35 goes to step e4. At step e3, the CPU 35 performs the operation shown at steps al to a6 shown in FIG. 4 for changing the display order of the program descriptions arranged for each time period, and goes to step e12.

At step e4, the CPU 35 determines whether or not the output signal from the input unit 28 is a command for changing the display order of the program descriptions arranged for each broadcast station. If the output signal is a command for changing the order for each broadcast station, the CPU 35 goes to step e5; otherwise, the CPU 35 goes to step e6. At step e5, the CPU 35 performs the operation shown at steps b1 to b6 shown in FIG. 6 for changing the display order of the program descriptions arranged for each broadcast station, and goes to step e2.

At step e6, the CPU 35 determines whether or not the output signal from the input unit 28 is a command for changing the broadcast station arranging order. If the output signal is a command for changing the broadcast station arranging order, the CPU 35 goes to step e7; otherwise, the CPU 35 goes to step e8. At step e7, the CPU 35 performs the operation shown at steps c1 to c5 shown in FIG. 8 for changing the broadcast station arranging order, and goes to step e12.

At step e8, the CPU 35 determines whether or not the output signal from the input unit 28 is a command for adding and displaying copied program descriptions. If the output signal is a command for adding and displaying copied program descriptions, the CPU 35 goes to step e9; otherwise, the CPU 35 goes to step e10. At step e9, the CPU 35 performs the operation shown at steps d1 to d6 shown in FIG. 11 for adding and displaying copied program descriptions, and goes to step e12.

At step e10, the CPU 35 determines whether or not the output signal from the input unit 28 is a command for displaying a default program guide, namely, displaying a program guide arranging program descriptions in a predetermined order. If the output signal is a command for displaying a default program guide, the CPU 35 goes to step ell; otherwise, the CPU 35 goes to step e12. At step ell, the CPU 35 displays a program guide arranging program descriptions in a predetermined order, and goes to step e12.

At step e12, the CPU 35 determines whether or not a signal for completing display setting is input from the input unit 28. If a signal for completing display setting is input, the CPU 35 goes to step e13; otherwise, the CPU 35 goes to step e14. If a signal for completing display setting is not input, the CPU 35 returns to step e2 for continuing display setting. At step e13, the CPU 35 terminates the changing operation of the order in the program guide.

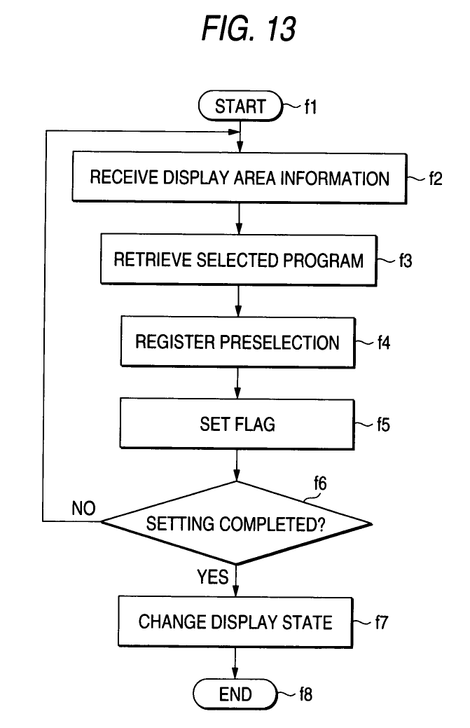

FIG. 13 is a flowchart to show the operation of the CPU 35 for storing a selected program. The program guide display apparatus 20 enables the operator to select, for example, preselect any program as the operator operates the switches 25a, 25b based on a display screen with the program description display order changed.

When the broadcast time period during which the program selected by the operator is broadcast comes, the program guide display apparatus 20 outputs a time arrival signal indicating that the broadcast time during which the selected program is broadcast comes. The time arrival signal is given to the reception unit 26, the control unit 27, and the record unit 41, whereby the program selected by the operator can be displayed or recorded in the broadcast time period. The CPU 35 serves as a broadcast time retrieval unit for retrieving the broadcast time of the program selected by the operator by executing a program stored in the ROM 36.

When the CPU 35 displays or records the selected program, the CPU 35 performs the operation of storing information concerning the selected program. First, at step f1, when the CPU 35 displays the program descriptions in the table format with the display order changed by performing the operation shown in FIG. 12 and is given a signal indicating start of the program selection operation from the input unit 28, the CPU 35 starts the operation of storing information concerning the selected program and goes to step f2.

At step f2, when the operator checks a display screen and selects the program description display area of the program to be selected by moving the cursor 49, the input unit 28 gives a signal indicating the program description display area selected by the operator to the CPU 35. Upon reception of the signal indicating the program description display area selected by the operator from the input unit 28, the CPU 35 goes to step f3.

At step f3, the CPU 35 reads the display order data from the RAM 36 and retrieves the program selected by the operator from the program data stored in the RAM 37 based on the received information indicating the program description display area and the display order data. Upon completion of retrieving the program selected by the operator, the CPU 35 goes to step f4.

At step f4, the CPU 35 acquires information indicating the broadcast station and the time period of the program selected by the operator, stores the broadcast station and the time period of the program selected by the operator in the RAM 37, and goes to step f5. At step f5, the CPU 35 sets a flag in the program data corresponding to the program selected by the operator and goes to step f6.

At step f6, upon reception of an output signal from the input unit 28, the CPU 35 determines whether or not program selection is complete. If program selection is continued, the CPU 35 returns to step f2 and performs the program selection operation. If program selection is complete, the CPU 35 goes to step f7. At step f7, the, CPU 35 again displays the program descriptions on the display screen according to the predetermined display order, and goes to step f8. At step f8, the CPU 35 terminates the program selection operation.

Upon completion of the selection operation, the CPU 35 again displays the program descriptions according to the predetermined display order. Thus, if the display order is sorted without any order to select a program, the display order is restored to the systematic display order, eliminating the need for restoring the program description display order to the former display order. For example, the predetermined display order is the display order in which the program descriptions are arranged in the main scanning direction H for each broadcast station and are arranged in the subscanning direction V in broadcast time sequence, for example, as shown in FIG. 2.

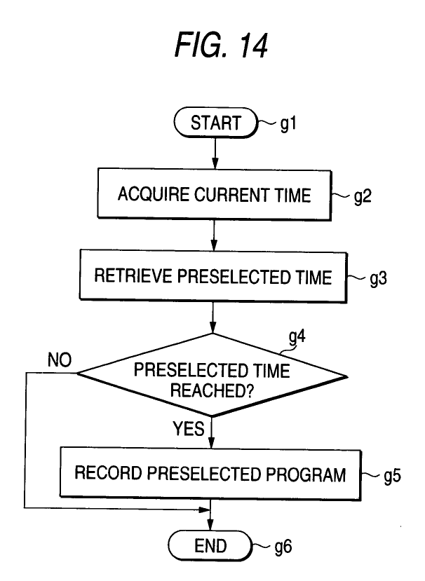

FIG. 14 is a flowchart to show the operation of the CPU 35 for recording a selected program. The CPU 35 serves as a time arrival signal output unit for outputting a signal indicating that the broadcast time at which the program selected by the operator is broadcast comes by executing a program stored in the ROM 36. The CPU 35 conducts an operation for recording the selected program after the operation of storing the selected program as shown in FIG. 13.

First, at step g1, if the selected program is stored in the RAM 37, the CPU 35 goes to step g2 and starts the operation of recording the selected program. At step g2, the CPU acquires the current time and goes to step g3.

At step g3, the CPU 35 retrieves preselected time stored in the RAM 37 and goes to step g4. At step g4, the CPU 35 determines whether or not the current time is the broadcast start time of the selected program. If the current time is the broadcast start time of the selected program, the CPU 35 outputs a signal indicating that the broadcast time of the program selected by the operator comes to the reception unit 26.

The CPU 35 gives a signal to the reception unit 26 so as to generate image data and audio data of the selected program, and stores the image data and the audio data generated by the reception unit 26 in the record unit 41 implemented as a hard disk, etc, so that the program can be played back.

If the broadcast end time of the selected program comes, the CPU 35 gives a command signal to the reception unit 26 to terminate reception, and goes to step g6. At step g6, the CPU 35 terminates the operation of recording the selected program.

The above described operation is the operation of recording the selected program. Alternatively, as another embodiment, when the broadcast time of the selected program comes, the selected program may be displayed in response to the time arrival signal. Also, the operator may be informed that the broadcast time of the selected program comes through the loudspeaker or display in response to the time arrival signal.

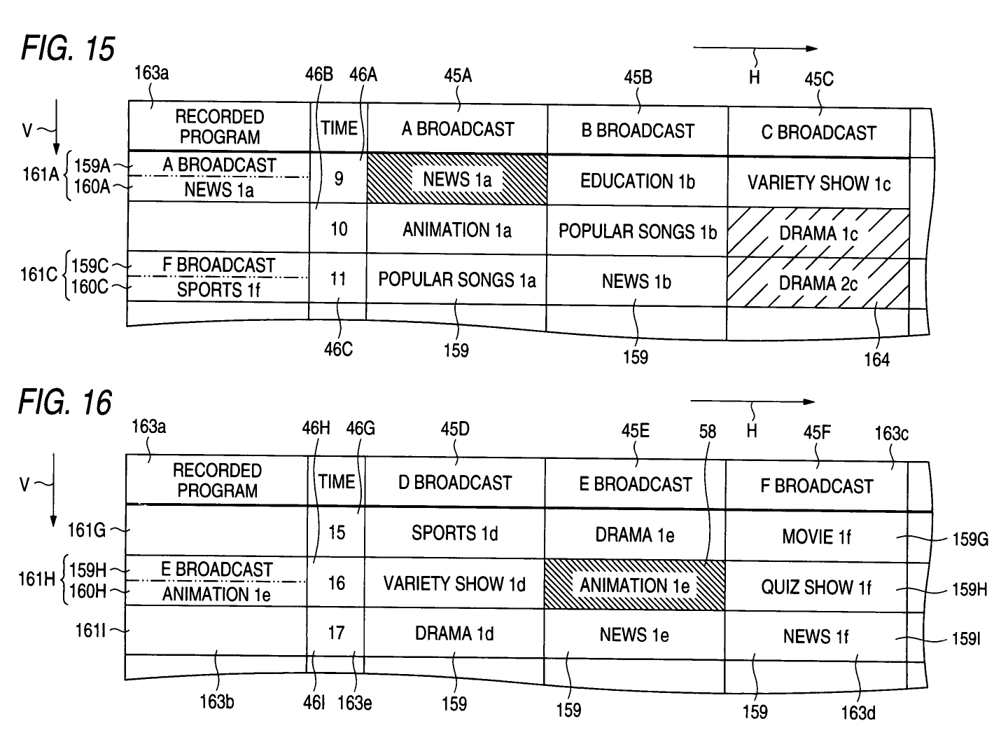

FIG. 15 is a drawing to show a part of the table format displayed with a selected program stored in the RAM 37. When the program selected by the operator is stored in the RAM 37, the CPU 35 displays a program description display area 158 in which the program description of the selected program is displayed and program description display areas 159 in which the program descriptions of other programs than the selected program are displayed in different display modes, for example, in different display colors. The display modes are thus changed for distinguishing the selected program from other programs on the display, thereby enabling the operator to keep track of the selected program in a short time and improving the convenience of the operator.

The CPU 35 sets an added program display position at which the program description of each selected program is displayed in the program guide displaying the program descriptions of programs and adds an added program description display area 161 displaying the program description of each selected program. For example, the added program description display area 161 is divided into two areas of one area 159 for displaying the broadcast station of the selected program and the other area 160 for displaying the description of the selected program.

The CPU 35 makes the program description display areas 159 and the added program description display area 161 contiguous with each other on the display. Specifically, the program description display areas 159 and the added program description display area 161 arranged in the main scanning direction H display the program descriptions of the programs broadcast in the same time period. Accordingly, the program description of the selected program and the program descriptions of other programs broadcast in the same time period as the selected program will be broadcast are arranged in the main scanning direction H, thus enabling the operator to easily compare the two program descriptions.

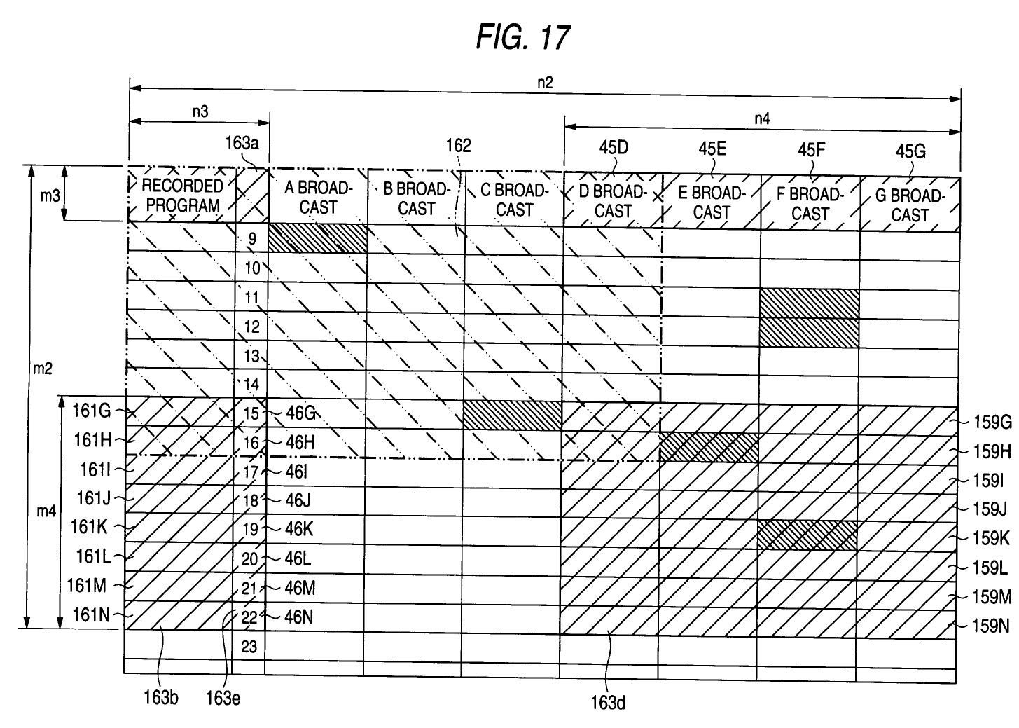

FIG. 16 is a drawing to show a part of the table format when the display screen is scrolled from the state shown in FIG. 15. FIG. 17 is a drawing to show a program guide represented by the image data stored in the expansion processing VRAM 56. In FIG. 17, display of program descriptions is not shown and a diagonally shaded area with chain double-dashed lines, 162, is an area displayed on the display 23 before scroll display and diagonally shaded areas with solid lines, 163a, 163b, 163c, 163d, and 163e, are areas displayed on the display 23 after scroll display.

If the number of received broadcast stations is large, the program guide display apparatus 20 displays some of all time periods and program descriptions of the broadcast stations as a program guide. As the operator operates the cursor move key 48 to move the cursor 49, the program guide display apparatus 20 scrolls the display screen. When the image is scrolled, the CPU 35 displays on the display screen a scroll area 163d having program description display areas 159 arranged continuously in the main scanning directions and the subscanning direction V, an added program description display area 163b corresponding to the program description display areas 159 making up the scroll area 163d, a time period display area 163e, and a broadcast station display area 163c. The added program description display area 163b and the time period display area 163e are contiguous in the main scanning direction H relative to the scroll area 63d. The broadcast station display area 163c is contiguous in the subscanning direction V relative to the scroll area 63d.

When the image is scrolled, program descriptions corresponding to program description display areas 159G to 159N making up the scroll area 163d are displayed in added program description display areas 161G to 161N and time period display areas 46G to 46N. For example, the program descriptions of the programs broadcast in the same time period are displayed in each of the program description display areas 159G to 159N and each of the added program description display areas 161G to 161N arranged in the main scanning direction H.

The time periods broadcasting the programs corresponding to the program descriptions displayed in the program description display areas 159G to 159N are displayed in the time period display areas 46G to 46N arranged in the main scanning direction H with respect to the program description display areas 159G to 159N. The broadcast stations for broadcasting the programs corresponding to the program descriptions displayed in the program description display areas 159 are displayed in broadcast station display areas 45D to 45G arranged in the subscanning direction V with respect to the program description display areas 159G to 159N.

Specifically, as shown in FIG. 16, the program description and the broadcast station of a selected program at 16:00 are displayed in the added program description display area 161H arranged in the main scanning direction H with respect to the program description display area 59H displaying the program descriptions of the programs broadcast at 16:00, and 16 is displayed in the time period display area 46H arranged in the main scanning direction H. E BROADCAST is displayed in the broadcast station display area 45E arranged in the subscanning direction V with respect to the program description display areas displaying the program descriptions of the programs broadcast from E broadcast.

Accordingly, if the image is scrolled, the program descriptions displayed in the program description display areas 159G to 159N making up the scroll area 163d can be displayed and the program description of the selected program can be displayed in the added program description display area 163b.

This eliminates the need for the operator to memorize the program description of the selected program and enables the operator to compare the program description of the selected program with that of each program displayed in the scroll area 63d. Since the expansion processing image data is stored in the expansion processing VRAM 56, the CPU 35 need not generate image data in sequence based on the program data and the display order data at the scroll display time and can produce scroll display smoothly.

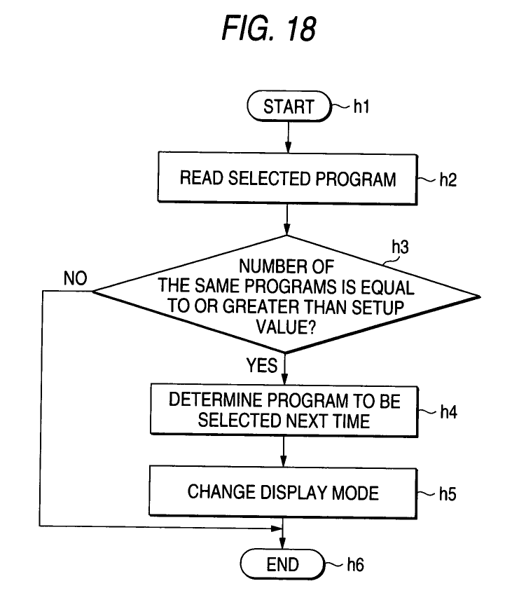

FIG. 18 is a flowchart to show the operation of the CPU 35 for selecting selected programs based on a selection history. The program guide display apparatus 20 stores the broadcast day of the week, the broadcast time period, the program name, and the program description of each program selected within a predetermined period into the RAM 37. If a plurality of programs broadcast at a predetermined interval, such as series drama, are selected, the CPU 35 estimates the next program to be selected in response to a selection history and selects the program.

When the selected program is stored in the RAM 37 at step h1, the CPU 35 goes to step h2 and starts the program selection operation based on the selection history. At step h2, the CPU 35 reads the selected programs from the RAM 37 and goes to step h3. At h3, the CPU 35 determines whether or not the same or similar programs are included among the selected programs. For example, if the titles of two programs are the same, the CPU 35 determines that the two programs are the same; if the program description of one program is similar to that of another program, the CPU 35 determines that the selected programs are similar programs.

The CPU 35 checks whether or not the program determined the same or similar is broadcast in the same time period at some interval. The CPU 35 counts the number of selection times of the program determined the same or similar in the same time period. If the count is equal to or greater than a predetermined count, the CPU 35 determines that the program needs to be also selected next time, and goes to step h4; otherwise, the CPU 35 goes to step h6.

At step h4, the CPU 35 selects the program determined to be also selected next time, stores the program in the RAM 37, and goes to step h5. At step h5, the CPU 35 changes the display mode of the program description display area displaying the program description of the program determined to be also selected next time, and goes to step h6. At step h6, the CPU 35 terminates the program selection operation based on the selection history.

In FIG. 15, a program description display area 164 displaying the program selected by the CPU 35 is hatched. The program description display area 164 displaying the program description of the program selected by the CPU 35 and the program description display area 158 displaying the program description of the program selected by the operator are displayed on the display 23 in different display modes. For example, the display mode can be changed by changing the display color of the program description display area. Accordingly, the operator can easily determine whether the program is selected by the operator or the CPU 35.

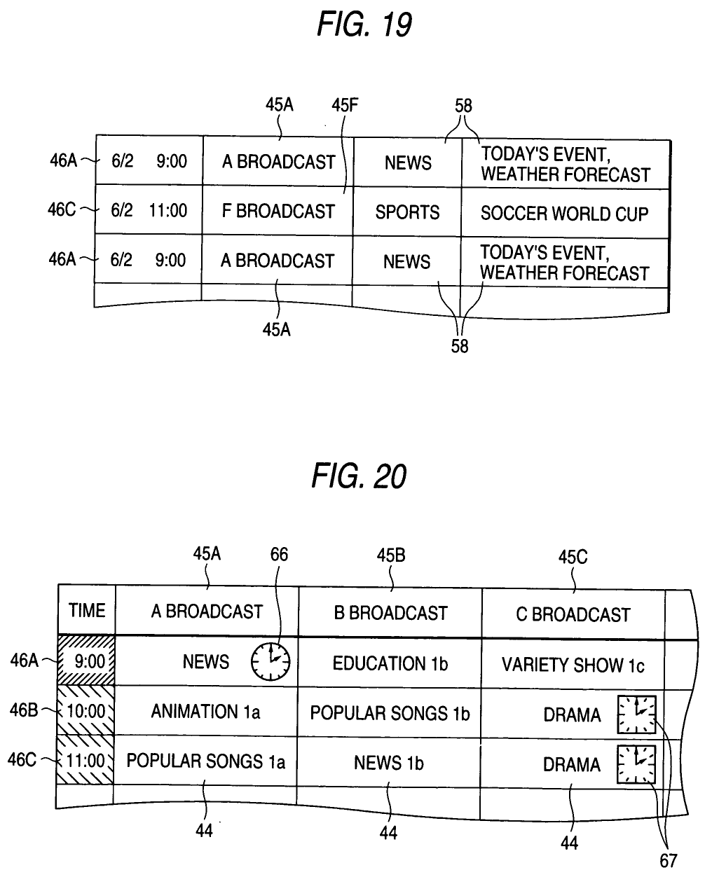

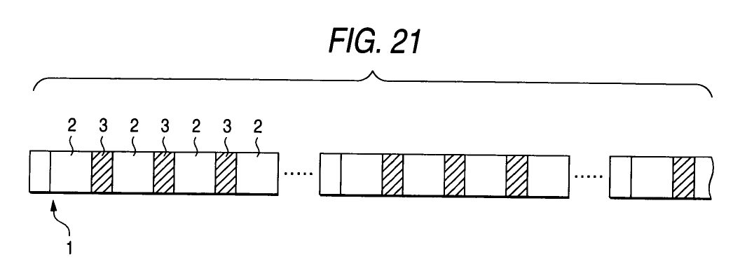

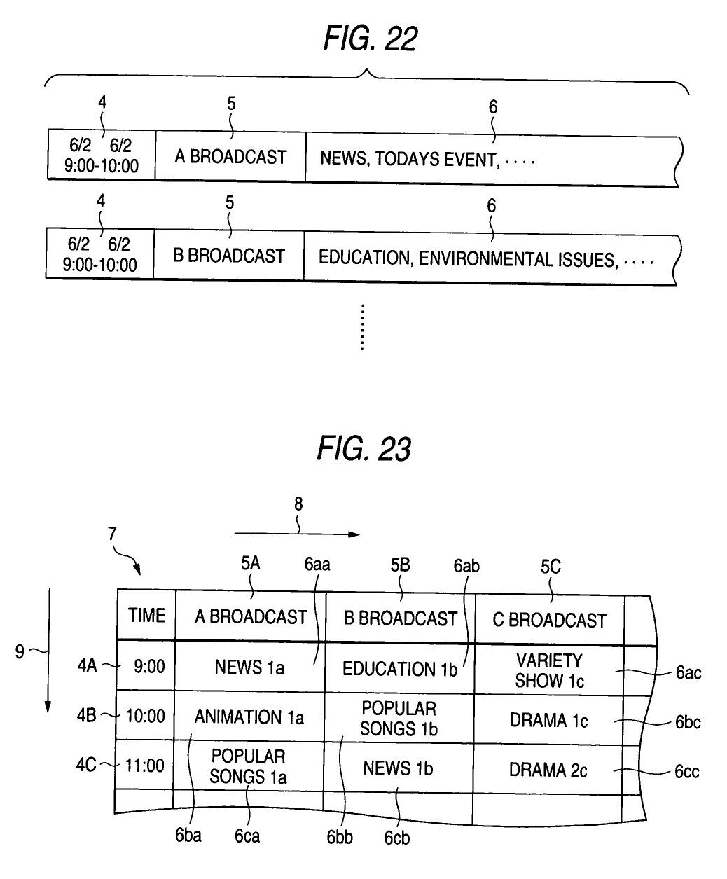

FIG. 19 is a drawing to show a program guide collecting the selected programs. The program guide display apparatus 20 further has a selected program display key (not shown) for preparing a program guide collecting the selected programs. As the operator operates the selected program display key, the CPU 35 reads the selected programs stored in the RAM 37 and controls the display 23 to display a program guide collecting the selected programs on a display screen.

The selected programs are displayed collectively, thereby enabling the operator to keep track of the program descriptions of the selected programs in a short time. For example, the number of the programs corresponding to the program descriptions displayed in one screen lessens and thus more detailed information on the program description of each selected program can be displayed on the display screen.

In the embodiment, as the CPU 35 executes the programs stored in the ROM 36, the CPU serves as the order change unit for controlling the display 23 so as to change the display positions of program descriptions in response to the command signal of the input unit 28, the program description copy unit for copying the program descriptions of programs, the program selection unit for selecting a program, the broadcast time retrieval unit for retrieving the broadcast time of the selected program, the time arrival signal output unit for outputting a time arrival signal indicating that the selected program reaches the broadcast time, and the count unit for counting the number of selection times of the programs having the same or similar program description among the selected programs in the same or similar time period at some interval. The program guide display apparatus 20 may have the means separately.

As described above, according to the program guide display apparatus 20, the program descriptions of programs are displayed in the table format in which the program descriptions are placed in the main scanning direction H and the subscanning direction V, and the display order of the program descriptions can be changed, so that the program guide in the display order responsive to the operator's liking can be displayed on the display 23 and the convenience of the operator can be improved.

For example, to compare the program descriptions of two different programs, the operator can change the display order of the program descriptions so as to display the program descriptions of the two programs in one screen, thereby comparing the program descriptions of the two programs on the display screen. This eliminates the need for the operator to scroll the screen to display the program description of the program to be checked and enables the operator to easily check the program description. A plurality of program descriptions are displayed in the table format on the display screen, whereby the operator can check a plurality of programs for each time period or for each broadcast station and can easily keep track of a plurality of program descriptions.

If the number of broadcast stations that can be viewed grows and all programs that can be viewed cannot be displayed in one screen as a program guide, the program descriptions of the programs in the time periods and from the broadcast stations to be checked by the operator can be collectively displayed on one screen and the operator can be saved from having to scroll the display image.

Since program data can be received, the most recent and accurate program data can be stored in the RAM 37 and the operator need not perform operation to acquire the program data.

The program description of the selected program is copied and displayed, whereby the operator can compare the copied program description with other program descriptions displayed on one screen and can compare the program descriptions without changing the display order in the table format.

The operator can select a program by moving the cursor 49 on the display screen after changing the display order of the program descriptions as described above, so that the operator can display the program descriptions to be checked on one screen and compare the program descriptions on the display screen for selecting a program. This eliminate the need for the operator to scroll the screen for each program selection and enables the operator to decrease program selection mistakes.

The CPU 35 operates the reception unit 26 and the display 23 in response to the time arrival signal in the time period broadcasting the selected program, whereby the selected program can be recorded or displayed. As the selected program is additionally displayed, the operator can keep track of already selected programs at a glance. Since the program descriptions of the already selected programs are also displayed in the selection operation, two programs broadcast in the same time period can be prevented from being double selected. The display area 58 displaying the program description of a selected program and the display area 59 displaying the program description of an unselected program are displayed in different display modes, so that the operator can distinguish the selected program from the unselected program at a glance.

Further, the CPU 35 estimates the next program to be selected and selects the program, so that the program that the operator forgets about selecting can be selected. Thus, the program broadcast serially every week, such as a serial drama, can be selected reliably. The display area 58 displaying the program description of the program selected by the operator and the display area 64 displaying the program description of the program estimated and selected by the program guide display apparatus are displayed in different display modes, so that the operator can easily check whether or not the program estimated and selected by the program guide display apparatus is the program to be selected.

The program guide display apparatus 20 may be installed in a vehicle, for example. To install the apparatus in a vehicle, if the display screen 43 of the display 23 is small, the operator changes the display order, whereby the program descriptions of the programs to be checked can be displayed in a table format and can be prevented from becoming indistinct and the operator need not scroll the screen and can keep track of the program descriptions reliably.

FIG. 20 is a drawing to show a part of a table format to show another display example. The display mode of the program description display area representing a selected program may be changed only. To change the display mode, symbols 66 and 67 indicating selection may be provided in the program description display area in addition to changing the display color of the program description display area. As such symbols are provided, the operator can also distinguish the selected programs from unselected programs in a short time.

The symbols may be provided as different symbols of the symbol 66 displayed in the program description display area displaying the program description of the program selected by the operator and the symbol 67 displayed in the program description display area displaying the program description of the program selected by the CPU 35. The display mode of the time period in which a program is selected may be changed. This enables the user to easily determine whether the program is selected by the operator or the CPU 35.

The described embodiment is for illustrative purpose only and it is to be understood that changes and variations may be made without departing from the spirit or scope of the invention. For example, the program guide display apparatus 20 may have a record medium read unit 40 for reading program data stored on a record medium that can be taken out from the program guide display apparatus 20, such as a compact disk (CD), and may not only acquire the program data from the reception unit 26, but also read the program data from the storage medium storing the program data. The program guided is play apparatus 20 may access a network connected to a telephone communication line, such as the Internet, through the communication modem 39 for reading program data; the program guide display apparatus 20 may have an acquisition unit for acquiring program data.

As the program guide, the program descriptions are arranged in the main scanning direction H for each broadcast station and are arranged in the subscanning direction V for each time period, but may be arranged in the subscanning direction V for each broadcast station and arranged in the main scanning direction H for each time period. The predetermined program description display order is set as default; in addition, the CPU 35 may store a different display order set by the operator changing the program description display order in the RAM 37 for adopting the operator-set display order as the predetermined program description display order.

The operator may use not only the cursor move keys 48 placed close to the display 23 for selecting a program in response to the display screen, but also the switches 25a placed on the remote control. The switches 58 to 61 for specifying various display order change patterns may be omitted and a menu screen may be displayed for the operator to set a display order change pattern using the cursor move keys 48.

According to the embodiment of the invention, the program descriptions of programs are displayed in a table format and the display order of the program descriptions can be changed in response to the operator's liking. Therefore, the operator can display the program descriptions to be checked in one screen collectively for each broadcast station to be checked, for each time period to be checked. Accordingly, the operator need not scroll the screen to display the program description of the program to be checked, and can easily check the program description. As a plurality of program descriptions are displayed in the table format on the display screen, the operator can check a plurality of programs for each time period or for each broadcast station, and can check a plurality of program descriptions in one screen.

According to the embodiment of the invention, the most recent program data can be stored in the memory, so that the operator can know the most recent program descriptions and the program corresponding to a different program description from the program description displayed on the display screen can be prevented from being broadcast. Since the storage medium storing the program data is not required, the operator need not take possession of the storage medium storing the program data at whatever time, and the convenience of the operator can be improved.

According to the embodiment of the invention, the order of the program descriptions arranged for each time period on the display can be changed, so that the convenience of the operator can be improved. For example, the program descriptions of the programs in the time period to be viewed by the operator can be collectively displayed at positions of the display screen where the operator can easily see the program descriptions. The program descriptions to be checked by the operator can be collectively displayed on the display screen, whereby the program guide display apparatus can reliably display the program descriptions to be checked by the operator even if the display screen is small. The program descriptions can be made easy to see.

According to the embodiment of the invention, the order of the program descriptions of the programs broadcast from the same broadcast station can be changed, so that the convenience of the operator can be improved. For example, the program descriptions of the programs of the broadcast station to be viewed by the operator can be collectively displayed at positions of the display screen where the operator can easily see the program descriptions. The program descriptions to be checked by the operator can be collectively displayed on the display screen, whereby the program guide display apparatus can reliably display the program descriptions to be checked by the operator even if the display screen is small. The program descriptions can be made easy to see.

The order of the program descriptions arranged for each broadcast station on the display can be changed, so that the convenience of the operator can be improved. For example, the program descriptions of the programs of the broadcast station to be checked by the operator for each time period can be collectively displayed at positions of the display screen where the operator can easily see the program descriptions. The program descriptions to be checked by the operator can be collectively displayed on the display screen, whereby the program guided is play apparatus can reliably display the program descriptions to be checked by the operator even if the display screen is small. The program descriptions can be made easy to see.

According to the embodiment of the invention, the copied program description and the program descriptions displayed in the table format can be arranged in one display screen, so that the operator can compare the copied program description with any other program description in one screen and can easily determine the program to be displayed.

According to the embodiment of the invention, the operator can check the description of each program before selecting the program. Since the program descriptions are displayed in the order responsive to the operator's liking on the display screen as described above, the operator can display the program descriptions to be checked in one screen and can compare programs to select a program. Accordingly, the operator need not scroll the screen more than once and can easily select any program.

According to the embodiment of the invention, the operator can check the description of each program before selecting the program. The operator need not scroll the screen more than once and can easily select any program. Since the program guide display apparatus can record the selected program, the operator can easily perform record operation of the program without any mistake before the program is broadcast.

According to the embodiment of the invention, the program description of the selected program can be added to the display screen, so that the operator can check the time period and the broadcast station of the selected program by seeing the display screen. Also in selection operation, the program descriptions of already selected programs are displayed and thus double selecting of two programs broadcast in the same time period can be prevented.

According to the embodiment of the invention, the display area displaying the program description of the selected program and the display area displaying the program description of an unselected program are displayed in different display modes, so that the operator can distinguish the selected programs from other programs at a glance. Accordingly, a selection error can be avoided and the selected program can be checked easily; the convenience of the operator can be improved.

According to the embodiment of the invention, the program guide display apparatus estimates and selects the next program to be selected, so that the program that the operator forgets about selecting can be selected. Accordingly, the program broadcast serially every week, such as a serial drama, can be selected reliably.

According to the embodiment of the invention, the display area displaying the program description of the program selected by the operator and the display area displaying the program description of the program estimated and selected by the program guide display apparatus are displayed in different display modes. Accordingly, the operator can check the program selected by the operator and the program selected by the program guide display apparatus from the display screen. For example, the operator can easily check whether or not the program estimated and selected by the program guide display apparatus is the program to be selected. If the operator does not want to select the program estimated by the program guide display apparatus, the operator can cancel selection of the program estimated by the program guide display apparatus.

What is claimed is:

1. A program guide display apparatus comprising:
a memory for storing a plurality of pieces of program data containing program descriptions of programs broadcast from broadcast stations and time periods at which the programs are broadcast;
a display unit having a two-dimensional display screen for displaying the program descriptions in a table format in which the program descriptions are arranged in a first direction and in a second direction crossing the first direction;
an input unit for outputting a command from an operator as a command signal; and
an order change unit for reading the program data stored in the memory and controlling the display unit to change an order of display positions of the program descriptions displayed in the table format in response to the command signal.

2. The apparatus according to claim 1, further comprising a reception unit for receiving a digital broadcasting including the program data,
wherein the memory stores the program data received by the reception unit.

3. The apparatus according to claim 1, wherein:
in the table format, the display positions of the program descriptions are arranged contiguously in the first direction for each of broadcast stations and are arranged contiguously in the second direction for each of time periods; and
the order change unit changes the order of the display positions of the program descriptions arranged contiguously in the second direction in response to the command signal.

4. The apparatus according to claim 1, wherein:
in the table format, the display positions of the program descriptions are arranged contiguously in the first direction for each of broadcast stations and are arranged contiguously in the second direction for each of time periods; and
the order change unit changes the order of the display positions of the program descriptions in the first direction for each of the broadcast stations in response to the command signal.

5. The apparatus according to claim 1, wherein:
in the table format, the display positions of the program descriptions are arranged contiguously in the first direction for each of broadcast stations and are arranged contiguously in the second direction for each of time periods; and
the order change unit changes the order of the display positions of the program descriptions arranged contiguously in the first direction.

6. The apparatus according to claim 1, further comprising a program description copy unit for copying at least one of the program descriptions in response to the command signal, wherein:
the order change unit sets a copy display position where the copied program description is displayed, separately from the display positions; and
the order change unit controls the display unit to display the copied program description contiguous to the program descriptions.

7. The apparatus according to claim 1, further comprising:
a first selection unit for allowing a user to select at least one of the programs;
a broadcast time retrieval unit for retrieving broadcast time of the selected program on the basis of the program data stored in the memory; and
a time arrival signal output unit for outputting a time arrival signal indicating that the broadcast time of the selected program comes, when the retrieved broadcast time comes.

8. The apparatus according to claim 7, further comprising a record unit for recording at least one of video and audio of the selected program in response to the time arrival signal output from the time arrival signal output unit.

9. The apparatus according to claim 7, wherein
the order change unit sets an additional display position where the selected program description is displayed, separately from the display positions; and
the order change unit controls the display unit to display the selected program description contiguous to the program descriptions.

10. The apparatus according to claim 7, wherein the order change unit controls the display unit to display the program description of the selected program in a different mode from that of the program descriptions of the other programs.

11. The apparatus according to claim 7, further comprising
a count unit for counting number of times that programs, which are at least similar to each other and are broadcast at a predetermined interval, have been selected; and
a second selection unit for estimating and selecting a future program, which is similar to the similar programs and will be broadcast in the future, when the counted number is not smaller than a predetermined value.

12. The apparatus according to claim 11, wherein the order change unit controls the display unit to display the program description of the estimated and selected program in a different mode from that of the program descriptions of the other programs.

13. A program guide display method comprising:
storing a plurality of pieces of program data containing program descriptions of programs broadcast from broadcast stations and time periods at which the programs are broadcast;
displaying the program descriptions in a table format in which the program descriptions are arranged in a first direction and in a second direction crossing the first direction;
inputting a command;
reading the stored program data; and
changing an order of display positions of the program descriptions displayed in the table format on the basis of the input command.
